(19) United States
(12) Patent Application Publication
(10) Pub. No.: US 2025/0000059 A1
(43) Pub. Date: Jan. 2, 2025

(54) PET COLLAR

(71) Applicant: Pak Hei Wong, Dongguan (CN)

(72) Inventor: Pak Hei Wong, Dongguan (CN)

(21) Appl. No.: 18/224,767

(22) Filed: Jul. 21, 2023

(30) Foreign Application Priority Data
Jun. 29, 2023 (CN) 202321678828.3

(51) Int. Cl. A01K 27/00

(52) U.S. Cl. CPC A01K 27/001

(57) ABSTRACT

A pet collar with a highly breathable structure comprises a neck fixing collar and a peripheral partition. The peripheral partition is spliced with multiple single pieces, and the splicing gap between each single piece is more conducive to air circulation, thereby reducing the air barrier between the inner and outer sides of the neck cover after wearing, and enhancing the air circulation. It is also conducive to the evacuation of saliva after pets wear it, thereby reducing the accumulation of saliva. The peripheral partition is formed by splicing multiple single-piece partitions together, so that the neck cover as a whole has a certain supporting force; After the neck collar is worn by the pet, the single-piece partition can be bent when passing through the narrow passage, and it can rebound normally after passing through, which is better than the full-circle neck collar.

### CROSS-REFERENCE TO RELATED APPLICATIONS

This is a U.S. patent application which claims the priority and benefit of Chinese Patent Application Number 202321678828.3, filed on Jun. 29, 2023, the disclosure of which is incorporated herein by reference in its entirety.

### TECHNICAL FIELD

The present application relates to the technical field of pet products, in particular to a highly breathable collar.

### BACKGROUND

The pet neck collar is a tool to prevent pets from licking, also known as “Elizabeth collar”. Its main function is to block pets from licking wounds and speed up wound healing. The neck collars currently on the market are usually surrounded by hard plastic sheets or filled with cloth and polyester fibers for simple tightening. This type of collar has poor wearing comfort and airtightness, which will easily lead to increased moisture in the covered area of the pet's neck and breed skin diseases. The material of this type of neck collar is too hard, and the pet is bulky after wearing it, which makes it inconvenient to walk and has poor comfort; and when the pet wears this kind of neck collar to sleep, the collar is not soft enough, which affects normal sleep.

### SUMMARY

The main purpose of the present application is to provide a pet collar, which aims to solve the comfort, air circulation, breathability, practicality and aesthetics of the pet collar after wearing.

In order to achieve the above purpose, the present application provides that the pet collar comprising a collar and a peripheral partition;

The peripheral partition is spliced with multiple single-piece partitions and is stitched together with the collar;

Preferably, in an embodiment, the entire circle of the peripheral partitions is formed by splicing multiple partitions.

### BRIEF DESCRIPTION OF DRAWINGS

One or more embodiments are illustrated by accompanying figures. These illustrative descriptions do not constitute limitations on the embodiments. Elements in the figures with the same reference numerals denote similar elements. Unless otherwise stated, the figures in the drawings are not limited to scale.

FIG. 1 is the structural diagram of an embodiment of the pet collar of the present application;

FIG. 2 is a schematic diagram of splicing multiple partitions of the pet collar of the present application;

FIG. 3 is another splicing form of the pet collar of the present application.

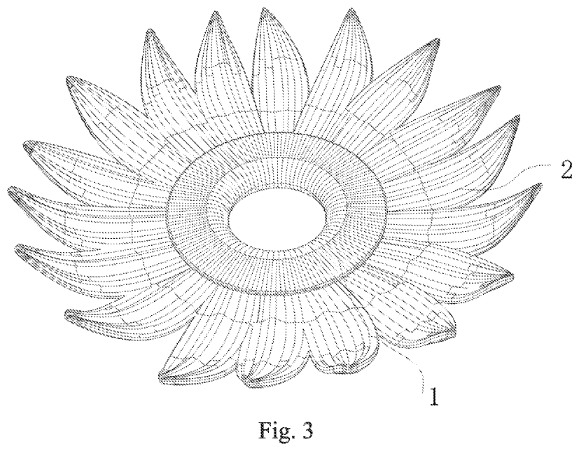

Reference signs: 1. Pet collar; 2. Pet collar partition.

### DETAILED DESCRIPTION

The following will clearly and completely describe the technical solutions in the implementation of the present application with reference to the accompanying drawings in the embodiments of the present application. Apparently, the described embodiments are only some of the embodiments of the present application, not all of them.

Examples of the described embodiments are shown in the drawings, wherein like or similar reference numerals designate like or similar elements or elements having the same or similar function throughout. The embodiments described below by referring to the figures are exemplary, and are intended to explain the present application, and should not be construed as limiting the present application.

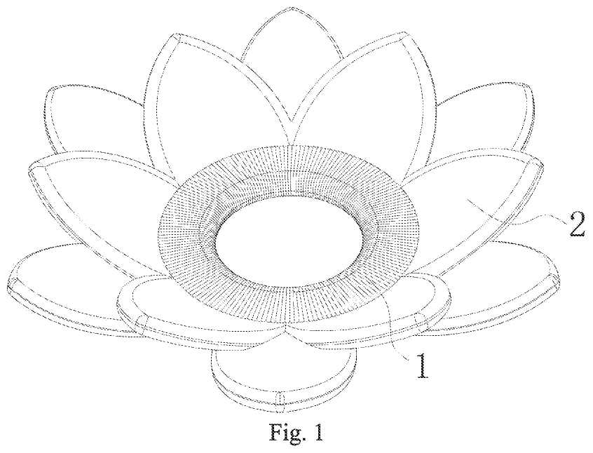

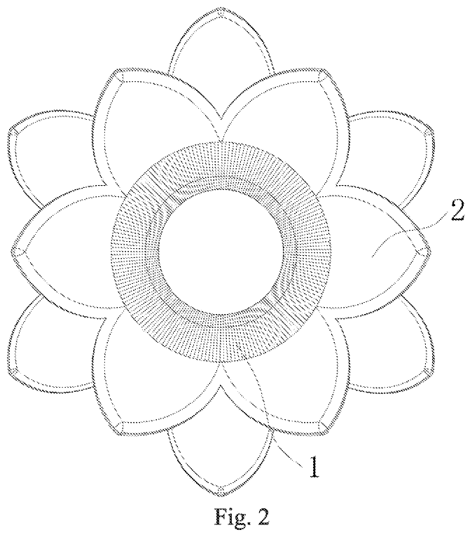

Please refer to FIG. 1 and FIG. 2, the fixing collar is combined with multiple piece partitions, and the peripheral partitions are spliced with multiple single piece partitions (2), a splicing gap between the single piece partitions is more conducive to air circulation. When worn for a long time, the front and rear space of the collar (1) has better air permeability, which reduces the accumulation of moisture, thereby reducing the risk of skin diseases caused by moisture accumulation. It is also conducive to the evacuation of saliva after pets wear it, thereby reducing the accumulation of saliva. The peripheral partition (2) is formed by splicing multiple single-piece partitions together, so that the peripheral partition of the collar is soft and plastic and has a certain supporting force. In the present application, the air fluidity and flexibility of the pet collar after wearing are improved by splicing and combining multi-piece partitions around the neck collar.

The above embodiments are only used to illustrate the technical solution of the present application, not to limit it. Under the idea of the present application, the technical features in the above embodiments or different embodiments can also be combined, the steps can be implemented in any order, and there are many other changes in different aspects of the present application as described above, for the sake of brevity, which are not provided in the details. Although the present application has been described in detail with reference to the foregoing embodiments, those of ordinary skill in the art should understand that: It is still possible to modify the technical solutions recorded in the foregoing embodiments, or perform equivalent replacements for some of the technical features; However, these modifications or replacements do not make the essence of the corresponding technical solutions depart from the scope of the technical solutions of the embodiments of the present application.

What is claimed is:

1. A pet collar with a highly breathable structure, comprising a neck fixing collar (1) and a peripheral partition (2);
the peripheral partition is spliced with multiple single piece partitions, and a splicing gap between the single piece partitions is more conducive to air circulation, thereby enhancing a breathability of a pet in a head area after wearing it; it is also conducive to the evacuation of saliva after the pet wears it and reduces the accumulation of saliva;
the peripheral partition is formed by splicing multiple pieces, so that the peripheral partition of the collar is soft and plastic and has a certain supporting force.

2. The pet collar according to claim 1, wherein a main function of the neck fixing collar is to fix the collar on the pet's neck.

3. The pet collar according to claim 1, wherein a plurality of single-piece partitions are spliced outside the fixing collar to form a peripheral enclosure; in terms of form, a large opening angle is used to increase the pet's field of vision; the splicing gaps between the single piece partitions are more conducive to air circulation; thereby reducing the air barrier between the inner and outer sides of the neck cover after wearing, and enhancing the air circulation, thereby forming an air circulation channel, reducing the air barrier between an inner and outer sides of the neck collar after wearing and enhancing the air circulation, when worn for a long time, a front and rear space of the collar has better air permeability, which reduces the accumulation of moisture, thereby reducing the risk of skin diseases caused by moisture accumulation.

4. The pet collar according to claim 3, wherein the peripheral partition is formed by splicing multiple pieces, so that the peripheral partition of the collar is soft and plastic and has a certain supporting force, the function is that the neck collar can be folded and rebound when the pet passes through the narrow environment after wearing the neck collar, and can effectively prevent the pet from licking the wound on the body.
